(19) United States
(12) Patent Application Publication
(10) Pub. No.: US 2024/0147210 A1
(43) Pub. Date: May 2, 2024

(54) METHOD AND DEVICE FOR COLLECTING DATA FOR ROAMING TERMINAL IN WIRELESS COMMUNICATION SYSTEM

(71) Applicant: Samsung Electronics Co., Ltd., Suwon-si (KR)

(72) Inventors: Jungshin PARK, Suwon-si (KR); Hyesung KIM, Suwon-si (KR)

(21) Appl. No.: 18/496,740

(22) Filed: Oct. 27, 2023

(30) Foreign Application Priority Data
Oct. 28, 2022 (KR) 10-2022-0141834

(51) Int. Cl. H04W 8/08

(52) U.S. Cl. CPC H04W 8/08; H04W 84/042

(57) ABSTRACT

The disclosure relates to a 5G or 6G communication system for supporting a higher data transmission rate. A method performed by a first network data analytics function (NWDAF) of a first public land mobile network (PLMN) in a communication system is provided. The method includes registering information on the first NWDAF to a first network repository function (NRF) of the first PLMN, transmitting, to the first NRF, a first message for requesting NWDAF information to collect, from an operator related to a second PLMN, analytics data for a roaming terminal, receiving, from the first NRF, a second message for providing information on a second NWDAF of the second PLMN, transmitting, to the second NWDAF, a third message for requesting the analytics data, based on the information on the second NWDAF, and receiving, from the second NWDAF, a fourth message notifying that provision of the analytics data is accepted.

### CROSS-REFERENCE TO RELATED APPLICATION

This application is based on and claims priority under 35 U. S.C. § 119 to Korean Patent Application No. 10-2022-0141834, filed on Oct. 28, 2022, in the Korean Intellectual Property Office, the present disclosure of which is herein incorporated by reference in its entirety.

### BACKGROUND

### 1. Field

The present disclosure relates to a method and a device for collecting data for a roaming terminal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the present disclosure. No determination has been made, and no assertion is made, as to whether any of the above might be applicable as prior art with regard to the present disclosure.

### SUMMARY

For performance improvement and operation optimization for a wireless communication system, functions of collecting and analyzing state information of a terminal within a system may be introduced. When a terminal roams to a network of another operator, an efficient method of collecting and transferring data between networks of operators is needed.

In order to achieve the above task, the present disclosure provides a method of configuring an operator's network information for supporting data collection of a roaming terminal and providing the network information to a roaming network.

In an embodiment, a method performed by a first network data analytics function (NWDAF) of a first public land mobile network (PLMN) in a communication system is provided. The method includes registering information on the first NWDAF to a first network repository function (NRF) of the first PLMN, transmitting, to the first NRF, a first message for requesting NWDAF information to collect, from an operator related to a second PLMN, analytics data for a roaming terminal, receiving, from the first NRF, a second message for providing information on a second NWDAF of the second PLMN, transmitting, to the second NWDAF, a third message for requesting the analytics data, based on the information on the second NWDAF, and receiving, from the second NWDAF, a fourth message notifying that provision of the analytics data is accepted.

In an embodiment, a method performed by a first NRF of a first PLMN in a communication system is provided. The method includes determining, based on an operator policy, information on a first NWDAF of the first PLMN, obtaining, from a second NRF of a second PLMN, information on a second NWDAF of the second PLMN, receiving, from the first NWDAF, a first message for requesting NWDAF information to collect, from an operator related to the second PLMN, analytics data for a roaming terminal, and transmitting, to the first NWDAF, a second message for providing the information on the second NWDAF.

In an embodiment, a first NWDAF of a first PLMN in a communication system is provided. The first NWDAF includes a transceiver and a controller operably coupled to the transceiver. The controller is configured to register information on the first NWDAF to a first NRF of the first PLMN, transmit, to the first NRF via the transceiver, a first message for requesting NWDAF information to collect, from an operator related to a second PLMN, analytics data for a roaming terminal, receive, from the first NRF via the transceiver, a second message for providing information on a second NWDAF of the second PLMN, transmit, to the second NWDAF via the transceiver, a third message for requesting the analytics data, based on the information on the second NWDAF, and receive, from the second NWDAF via the transceiver, a fourth message notifying that provision of the analytics data is accepted.

In an embodiment, a first NRF of a first PLMN in a communication system is provided. The first NRF includes a transceiver and a controller operably coupled to the transceiver. The controller is configured to determine, based on an operator policy, information on a first NWDAF of the first PLMN, obtain, from a second NRF of a second PLMN, information on a second NWDAF of the second PLMN, receive, from the first NWDAF via the transceiver, a first message for requesting NWDAF information to collect, from an operator related to the second PLMN, analytics data for a roaming terminal, and transmit, to the first NWDAF via the transceiver, a second message for providing the information on the second NWDAF.

According to the present disclosure, an efficient method is provided, the method being capable of collecting and transferring data between networks of operators when a terminal roams to a network of another operator.

Advantageous effects obtainable from the present disclosure may not be limited to the above-mentioned effects, and other effects which are not mentioned may be clearly understood, through the following descriptions, by those skilled in the art to which the present disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system structure of a 5GS according to an embodiment of the present disclosure;

FIG. 2 illustrates operation and device for configuring information for supporting data collection for a roaming terminal in an operator network and transferring necessary information between networks according to an embodiment of the present disclosure;

FIG. 3 illustrates a signal procedure of a wireless communication system for configuring network information to support data collection for a roaming terminal according to an embodiment of the present disclosure;

FIG. 4 illustrates a signal procedure of the wireless communication system for data collection for a roaming terminal according to an embodiment of the present disclosure;

FIG. 5 illustrates a signal procedure of the wireless communication system for changing or blocking data collection for a roaming terminal based on a change in configuration information of an operator network according to an embodiment of the present disclosure; and

FIG. 6 illustrates a structure of a network entity according to an embodiment of the present disclosure.

### DETAILED DESCRIPTION

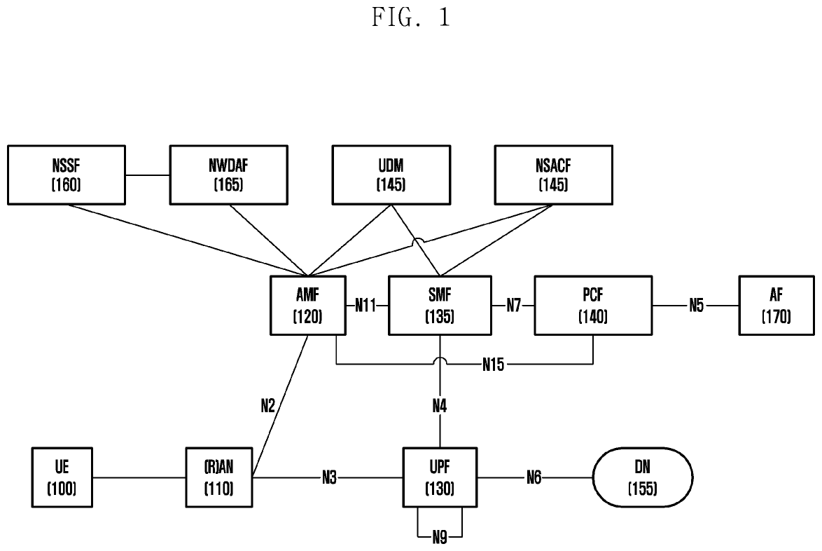

FIGS. 1 through 6, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

Hereinafter, embodiments of the present disclosure will be described in detail in conjunction with the accompanying drawings. In the following description of the present disclosure, a detailed description of known functions or configurations incorporated herein will be omitted when it is determined that the description may make the subject matter of the present disclosure unnecessarily unclear. The terms which will be described below are terms defined in consideration of the functions in the present disclosure, and may be different according to users, intentions of the users, or customs. Therefore, the definitions of the terms should be made based on the contents throughout the specification.

The advantages and features of the present disclosure and ways to achieve them will be apparent by making reference to embodiments as described below in detail in conjunction with the accompanying drawings. However, the present disclosure is not limited to the embodiments set forth below, but may be implemented in various different forms. The following embodiments are provided only to completely disclose the present disclosure and inform those skilled in the art of the scope of the present disclosure, and the present disclosure is defined only by the scope of the appended claims. Throughout the specification, the same or like reference numerals designate the same or like elements.

Hereinafter, the present disclosure relates to a method and a device for supporting various services in a wireless communication system. For example, the present disclosure may be applied as a technology to support performance improvement of split computing, by providing necessary state information and managing requests for communication session information received from a terminal and an application server using split computing in the wireless communication system.

In the following description, terms for identifying access nodes, terms referring to network entities, terms referring to messages, terms referring to interfaces between network entities, terms referring to various identification information, and the like are illustratively used for the sake of descriptive convenience. Therefore, the present disclosure is not limited by the terms as used below, and other terms referring to subjects having equivalent technical meanings may be used.

In the following description of the present disclosure, terms and names defined in the 3rd generation partnership project long term evolution (3GPP LTE) and 5G standards will be used for the sake of descriptive convenience. However, the present disclosure is not limited by these terms and names, and may be applied in the same way to systems that conform other standards.

Hereinafter, for convenience of description, NF names (e.g., AMF, SMF, NSSF, etc.) are used for objects that exchange information for access control and state management. However, embodiments of the present disclosure may be equally applied even when an NF is actually implemented as an instance (each of an AMF instance, an SMF instance, an NSSF instance, etc.).

FIG. 1 illustrates a system structure of a 5GS according to an embodiment of the present disclosure.

Referring to FIG. 1, the 5GS may include a 5G core network, a base station, a terminal, and the like. The 5G core network (or 5G core network) may include an AMF 120, an SMF 135, a UPF 130, a PCF 140, UDM 145, an NSSF 160, an NWDAF 165, an N3F, and the like.

A terminal 100 may access the 5G core network via a radio-access network base station 110. The access network base station 110 may support a 3GPP access network (e.g., NR, E-UTRA, etc.) type or a non-3GPP access network (e.g., Wi-Fi, etc.) type. Via the base station 110, the terminal 100 may be connected to the AMF 120 via an N2 interface and connected to the UPF 130 via an N3 interface. The base station 110 may be referred to as, in addition to base station, “access point (AP),” “eNodeB (eNB),” “5th generation node (5G node),” “gNodeB (gNB),” or other terms having an equivalent technical meaning. The non-3GPP function (N3F) is a network function (NF) operating as N2 interface and N3 interface terminations for the terminal 100 connected via an access network (non-3GPP access network) (e.g., Wi-Fi, etc.) that is not defined in 3GPP. The N3F may process N2 control plane signaling and an N3 user plane packet.

The access and mobility management function (AMF) 120 is a network function (NF) configured to manage wireless network access and mobility for the terminal (UE). The session management function (SMF) 135 is an NF configured to manage a sessions for the terminal, and session information includes QoS information, charging information, and information on packet processing. The user plane function (UPF) 130 is an NF configured to process user traffic (user plane traffic) and is controlled by the SMF 135. The policy control function (PCF) 140 is an NF configured to manage an operator policy for providing a service in the wireless communication system. The user data management (UDM) 145 is an NF configured to store and manage subscriber information (UE subscription) of the terminal. A unified data repository (UDR) is an NF configured to store and manage data. The UDR may store terminal subscription information and provide the terminal subscription information to the UDM.

In addition, the UDR may store operator policy information and provide the operator policy information to the PCF. The network data analytics function (NWDAF) 165 is an NF configured to provide analysis information for the 5G system to operate. The NWDAF may collect data from operations, administration, and maintenance (OAM) or other NFs constituting the 5G system, analyze the collected data, and provide analysis results to other NFs. A network slice admission control function (NSACF) 180 is an NF configured to monitor and control the number of sessions and the number of registered terminals of a network slice subject to network slice admission control (NSAC). The NSACF stores configuration information on a maximum number of sessions and a maximum number of registered terminals for each network slice.

Hereinafter, for convenience of description, objects that exchange information for access control and state management may be collectively referred to as NF. However, embodiments of the present disclosure may be equally applied even when an NF is actually implemented as an instance (each of an AMF instance, an SMF instance, an NSSF instance, etc.).

In the present disclosure, a specific NF exists in the form of software codes in an instance, and the instance may refer to a state in which, in order to perform an NF function in a physical computing system, for example, a specific computing system existing on a core network, physical and/or logical resources are allocated from the computing system so as to enable execution of the NF function. Therefore, each of an AMF instance, an SMF instance, and an NSSF instance may indicate that, for AMF, SMF, and NSSF operations, physical and/or logical resources may be allocated from a specific computing system existing on a core network so as to be used.

As a result, the same operations may be performed in a case where physical AMF, SMF, NS SF devices exist, and in a case of AMF, SMF, and NSSF instances in which physical and/or logical resources are allocated from a specific computing system existing on a core network so as to be used to perform AMF, SMF, NS SF operations. Therefore, in embodiments of the present disclosure, an item described as an NF (AMF, SMF, UPF, NSSF, NRF, SCP, etc.) may be replaced with an NF instance or, conversely, an item described as an NF instance may be replaced with an NF. Likewise, in embodiments of the present disclosure, an item described as a network slice may be replaced with a network slice instance or, conversely, an item described as a network slice instance may be replaced with a network slice so as to be applied.

According to an embodiment of the present disclosure, in the 5G system defined in 3GPP, one network slice may be referred to as single-network slice selection assistance information (S-NSSAI). S-NSSAI may include a slice/service type (SST) value and a slice differentiator (SD) value. The SST may indicate a characteristic (e.g., eMBB, IoT, URLLC, V2X, etc.) of a service supported by a slice. The SD may be a value used as an additional identifier for a specific service referred to as SST.

NSSAI may include one or more pieces of S-NSSAI. Examples of NS SAI may include configured NS SAI stored in a terminal, requested NS SAI requested by a terminal, allowed NS SAI allowed to be used by a terminal determined by the NF of the 5G core network (e.g., AMF, NSSF, etc.), a subscribed NS SAI to which a terminal is subscribed, etc., and the present disclosure is not limited to the examples.

The terminal 100 may be concurrently connected to the access network 110 so as to be registered in the 5G system. Specifically, the terminal 100 may access the base station 110 and perform a terminal registration procedure with the AMF 120. During the registration procedure, the AMF 120 may determine an allowed slice (allowed NSSAI) available for the terminal connected to the base station 110 and assign the same to the terminal 100. The terminal may select a specific slice to establish a PDU session for communication with an actual application server. One PDU session may include one or multiple quality of service (QoS) flows, and respective QoS flows may provide different transmission performance required for respective application services by configuring different QoS parameters.

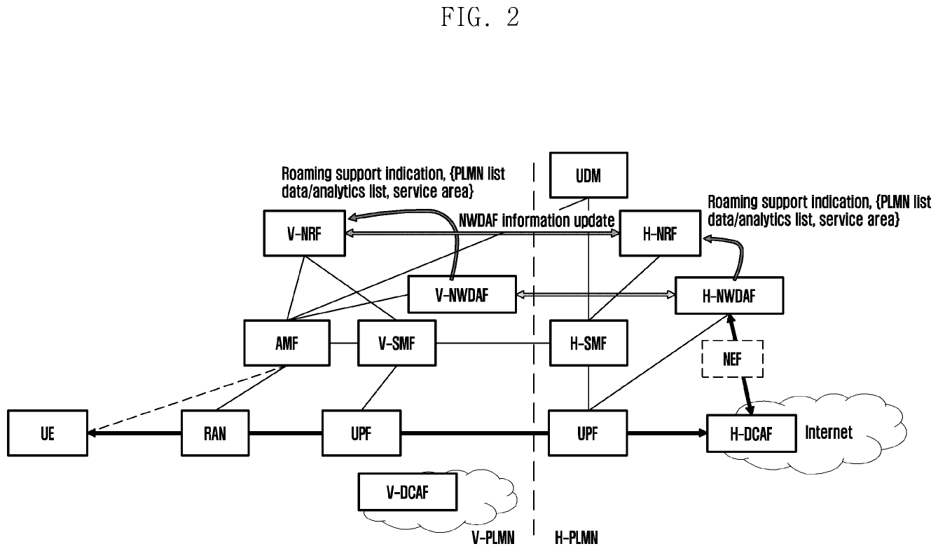

FIG. 2 illustrates a general operation and device for configuring information for supporting data collection for a roaming terminal in an operator network and transferring necessary information between networks according to an embodiment of the present disclosure.

When describing a general operation of a provided embodiment with reference to FIG. 2, a user may subscribe to a communication service of an operator in order to receive a wireless communication service. In addition, with consent of the user, the operator may collect state data for the user and a terminal used by the user from a network and the terminal and may analyze and use the same to improve performance. In preparation for a case where the terminal roams, the operator may determine terminal and user data, an analysis type, etc. for the terminal, which are providable to a roaming operator, according to operator policies, legal regulations, roaming agreements between operators, and the like, may select an NWDAF to be used to transfer the data and analysis information to a network of the roaming operator, and may configure, for the NWDAF, information such as the terminal and user data, the analysis type, etc. determined for the roaming operator.

In this case, the operator (hereinafter, referred to as a home operator when distinction from a roaming operator is necessary for understanding of contents) is able to make roaming contracts with multiple roaming operators, and may perform configuration to provide each roaming operator with a different NWDAF and user/terminal data and analysis information having different contents.

The NWDAF may register, in a network repository function (NRF), the configuration information of the NWDAF configured by the home operator. Registration information may include at least one piece of the following information, for example, information of an indicator indicating whether the NWDAF supports roaming, a network identifier (PLMN ID) of a roaming operator, a data type (e.g., a data ID list) providable to the roaming operator, an analysis type (e.g., an analysis ID list) providable to the roaming operator, a service area allowed to provide data and analysis information to the roaming operator, and the like.

The NRF of a home operator network may receive, from the NWDAF, information related to information providing during the roaming, and store the same. When requested by the network of the roaming operator, the NRF may, based on the stored information, provide the network of the roaming operator with information on the NWDAF configured to provide the data and analysis information to the roaming operator and the roaming terminal by the home operator. Alternatively, whenever the information of the NWDAF to be used for information providing during roaming is changed according to implementation, roaming contracts between operators, etc., the NRF may transmit the information of the NWDAF to a visited PLMN NRF (V-NRF) installed in the network of the roaming operator (designated by the roaming operator).

In this case, the V-NRF may store the NWDAF information received from the NRF of the home operator network, and in a later operation, when a V-NWDAF of the roaming operator network requests the NWDAF information of the home operator network, which is to be used to request data and analysis information for the roaming terminal, the V-NRF may provide the stored information to the V-NWDAF.

Similar to configuring, for the NWDAF and NRF by the operator, the terminal and user data or analysis information for the terminal, which are providable to each roaming operator, the roaming operator may configure, for the V-NWDAF of the roaming operator network, the terminal and user data, analysis information, or the like for the roaming terminal, which are providable to the home operator network. That is, in preparation for a case where a terminal of the home operator roams, the roaming operator may determine terminal and user data, an analysis type, etc. for the terminal, which are providable to the home operator network, according to operator policies, legal regulations, roaming agreements between operators, and the like, may select a V-NWDAF to be used to transfer the data and analysis information to the home operator network, and may configure, for the V-NWDAF, information such as the terminal and user data, the analysis type, etc. determined for the home operator.

In this case, the roaming operator is able to make roaming contracts with multiple home operators and may perform configuration to provide each home operator with a different V-NWDAF and user/terminal data and analysis information having different contents.

The V-NWDAF may register, in a V-NRF, the configuration information of the V-NWDAF configured by the roaming operator. Registration information may include at least one piece of the following information, for example, information of an indicator indicating whether the V-NWDAF supports roaming, a network identifier (PLMN ID) of the home operator, a data type (e.g., a data ID list) providable to the home operator, an analysis type (e.g., an analysis ID list) providable to the home operator, a service area allowed to provide data and analysis information to the home operator, and the like.

The V-NRF of the roaming operator network may receive, from the V-NWDAF, information related to information providing during the roaming, and store the same. When requested by the home operator network, the V-NRF may, based on the stored information, provide the home operator network with information on the V-NWDAF configured to provide the data and analysis information to the home operator and the roaming terminal by the roaming operator. Alternatively, whenever the information of the V-NWDAF to be used for information providing during roaming is changed according to implementation, roaming contracts between operators, etc., the V-NRF may transmit the information of the V-NWDAF to a home PLMN NRF ((H-)NRF) installed in the home operator network (designated by the home operator). In this case, the (H-)NRF may store the V-NWDAF information received from the V-NRF of the roaming operator network, and in a later operation, when an (H-)NWDAF of the home operator network requests the V-NWDAF information of the roaming operator network, which is to be used to request data and analysis information for the roaming terminal, the (H-)NRF may provide the stored information to the (H-)NWDAF.

When the (H-)NWDAF of the home operator network needs analysis information or needs to collect terminal and user data for the roaming terminal from the roaming operator network, the (H-)NWDAF may request and receive, from the (H-)NRF, V-NWDAF information allowed by the roaming operator, may use the received information to request the V-NWDAF to provide the collected terminal and user data or the analysis information for the roaming terminal, and may receive necessary information from the V-NWDAF. Similarly, when the V-NWDAF of the roaming operator network needs analysis information or needs to collect terminal and user data for the roaming terminal from the home operator network, the V-NWDAF may request and receive, from the V-NRF, (H-)NWDAF information allowed by the home operator, may use the received information to request the (H-)NWDAF to provide the collected terminal and user data or the analysis information for the roaming terminal, and may receive necessary information from the (H-)NWDAF.

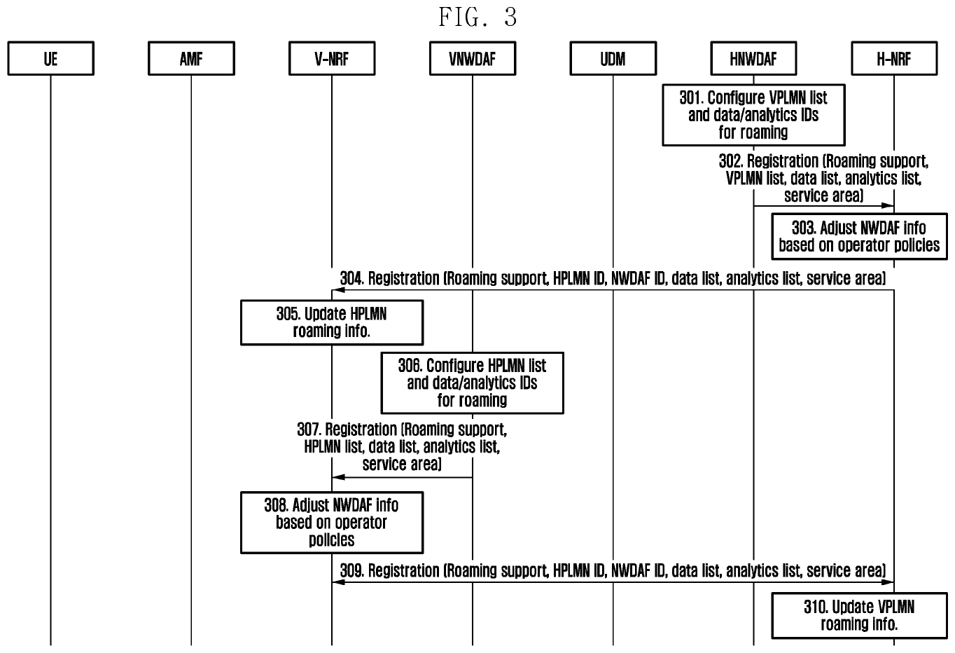

FIG. 3 illustrates a signal procedure of the wireless communication system for configuring network information to support data collection for a roaming terminal according to an embodiment of the present disclosure.

When describing a general operation of a provided embodiment with reference to FIG. 3, in operation 301, in preparation for roaming of a terminal, a home operator may configure, for a home PLMN NWDAF (H-NWDAF) of a home network, at least one piece of information, such as roaming operator network (visited PLMN) information allowed for each terminal, and terminal and user information and an analysis type which are providable to a roaming operator network. The roaming operator network information may be an identifier (VPLMN ID) of a roaming operator network, and the terminal and user information and the analysis type, which are providable to the roaming operator network, may correspond to multiple data IDs and multiple analysis IDs, respectively. In addition, the information may be configured differently for each roaming operator network. For example, multiple information element sets may be provided, and each information element set may include, for example, {VPLMN ID, list of data ID, list of analytics ID}. The home operator may configure for the H-NWDAF whether the H-NWDAF can be used to transfer the designated information to the roaming operator network.

In operation 302, the H-NWDAF may register, with an H-NRF, the H-NWDAF information configured by the operator in operation 301. A registration request message transmitted to the H-NRF from the H-NWDAF during the registration may include at least one of the following information, for example, an indicator indicating whether the H-NWDAF is allowed to provide information on the roaming terminal to a roaming operator network, information (e.g., VPLMN IDs) of roaming operator networks allowed for information providing, data or analysis types (e.g., data IDs or analytics IDs) allowed for each roaming operator network, service area information (e.g., a service area (a TA list, cell IDs, etc.)), for which information transfer is allowed, for each roaming operator network, and the like. In this case, the allowed data or analysis types, the allowed service area, etc. may be configured differently for each roaming operator network. Also, depending on implementation, information of terminal identifiers for which information transfer is allowed may be additionally provided for each roaming operator network.

In operation 303, the H-NRF may store the information received from the H-NWDAF via operation 302, and may determine, by applying an operator policy, etc., content of the H-NWDAF information to be provided to each roaming operator network. For example, according to the operator policy, the number of available H-NWDAFs may be changed and provided for each roaming operator, or only an H-NWDAF ID may be provided without providing allowable terminal and user data types, analysis type, or service area information.

In operation 304, the H-NRF may transmit publicly-available H-NWDAF information determined in operation 303 to a V-NRF designated by each roaming operator. In this case, the H-NRF may transmit the H-NWDAF information to the V-NRF designated by each roaming operator via a roaming agreement procedure, etc. Registration request information for the H-NWDAF transmitted to the V-NRF by the H-NRF may include all registration information provided by the H-NWDAF or may include only some of the registration information via the determination in operation 303. The registration request information may include at least one of the following information, for example, an indicator indicating whether the home operator network is allowed to provide information on the roaming terminal to a roaming operator network, a home operator network identifier (HPLMN ID), data or analysis types (e.g., data IDs or analytics IDs) allowed to a corresponding roaming operator network that receives a registration request message, service area information (e.g., a service area (a TA list, cell IDs, etc.)) for which information transfer is allowed, etc.

When configuration is performed differently for a specific terminal, applied terminal identifier information may be included. Depending on implementation, operation 304 may be performed, instead of being performed after operation 303, after receiving a message for requesting the H-NWDAF information from the V-NRF during requesting of the H-NWDAF information of the home operator network from the V-NRF in order for a V-NWDAF to request the terminal and user data or analysis information from the home operator network.

In operation 305, the V-NRF may store the H-NWDAF information and HPLMN information received from the H-NRF.

Operation 306 to operation 310 are procedures of configuring the V-NWDAF and the V-NRF so as to enable a roaming operator to provide terminal and user data and analysis information for the roaming terminal to the home operator network from the roaming operator network, and may be performed similarly to the procedures performed in operation 301 to operation 305 described above.

In operation 306, in preparation for roaming of the terminal, the roaming operator may configure, for the visited PLMN NWDAF (V-NWDAF) of the roaming operator network, information, such as allowed home operator network (home PLMN) information, and terminal and user information and an analysis type which are providable to each home operator network. The home operator network information may be an identifier (HPLMN ID) of the home operator network, and the terminal and user information and the analysis type, which are providable to the home operator network, may be multiple data IDs and multiple analysis IDs, respectively. In addition, the information may be configured differently for each home operator network, and multiple pieces of information in a form of, for example, {HPLMN ID, list of data ID, list of analytics ID} may be provided. The roaming operator may configure, for each V-NWDAF, whether a corresponding V-NWDAF may be used to transfer the designated information to the home operator network.

In operation 307, the V-NWDAF may register, with the V-NRF in the roaming operator network, the V-NWDAF information configured by the roaming operator in operation 306. A registration request message transmitted to the V-NRF from the V-NWDAF during the registration may include at least one of the following information, for example, an indicator indicating whether the V-NWDAF is allowed to provide information on the roaming terminal to a home operator network, information (e.g., HPLMN IDs) of home operator networks allowed for information providing, data or analysis types (e.g., data IDs or analytics IDs) allowed for each home operator network, service area information (e.g., a service area (a TA list, cell IDs, etc.)), for which information transfer is allowed, for each home operator network, and the like. In this case, the allowed data or analysis types, the allowed service area, etc. may be configured differently for each home operator network. Also, depending on implementation, information of terminal identifiers for which information transfer is allowed may be additionally provided for each home operator network.

In operation 308, the V-NRF may store the information received from the V-NWDAF via operation 307, and may determine, by applying an operator policy, etc., to restrict content of the V-NWDAF information to be provided to each home operator network. For example, according to the operator policy, the number of available V-NWDAFs may be changed and provided for each home operator, or only a V-NWDAF ID may be provided without providing allowable terminal and user data types, analysis type, or service area information.

In operation 309, the V-NRF may transmit publicly-available V-NWDAF information determined in operation 308 to the H-NRF designated by each home operator. In this case, the V-NRF may transmit the V-NWDAF information to the H-NRF designated by each home operator via a roaming agreement procedure, etc. Registration request information for the V-NWDAF transmitted to the H-NRF by the V-NRF may include all registration information provided by the V-NWDAF or may include only some of the registration information via the determination in operation 308. The registration request information may include at least one of the following information, for example, an indicator indicating whether the roaming operator network is allowed to provide information on the roaming terminal to a home operator network, a roaming operator network identifier (VPLMN ID), data or analysis types (e.g., data IDs or analytics IDs) allowed to a corresponding home operator network that receives a registration request message, service area information (e.g., a service area (a TA list, cell IDs, etc.)) for which information transfer is allowed, etc., and when configuration is performed differently for a specific terminal, applied terminal identifier information may be included.

Depending on implementation, operation 309 may be performed, instead of being performed after operation 308, after receiving a message for requesting the V-NWDAF information from the H-NRF during requesting of the V-NWDAF information of the roaming operator network from the H-NRF in order for the H-NWDAF to request the terminal and user data or analysis information from the roaming operator network.

In operation 310, the H-NRF may store the V-NWDAF information and VPLMN information received from the V-NRF.

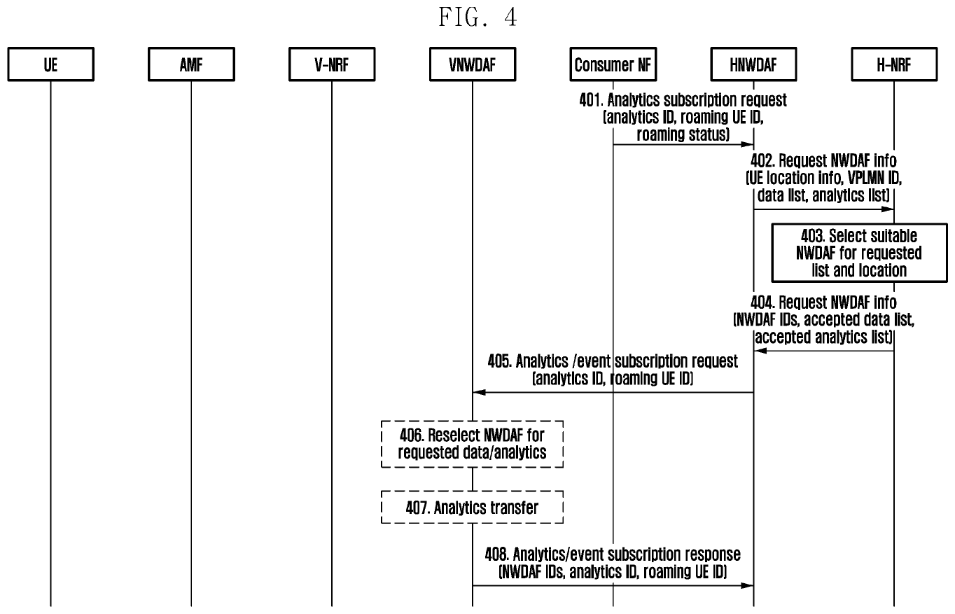

FIG. 4 illustrates a signal procedure of the wireless communication system, for data collection for a roaming terminal according to an embodiment of the present disclosure.

When describing a general operation of a provided embodiment with reference to FIG. 4, in operation 401, an H-NWDAF of a home operator network may receive an analysis subscription request message for requesting data analysis for a roaming terminal from a consumer NF of the home operator network. The analysis subscription request message may include at least one of the following information, for example, an analytics ID designating analysis information, an identifier of the roaming terminal, roaming state information, etc.

In operation 402, the H-NWDAF may determine to collect terminal and user data or analysis information, as data necessary for analysis, from a roaming operator network. The H-NWDAF may request, from an H-NRF, V-NWDAF information designated for information providing by a roaming operator in order to request the information of the roaming terminal from the roaming operator network. The request message may include at least one piece of the following information, for example, information (or some thereof) such as a terminal identifier, current location information of the terminal, a roaming operator network identifier (e.g., VPLMN ID), a list of data type(s) to be requested, and a list of analysis type(s) to be requested. The current location information of the terminal may be, for example, a TA list or a cell ID.

In operation 403, by referring to V-NWDAF information received from a V-NRF of the roaming operator so as to be stored via the procedure in FIG. 3, the H-NRF may select an appropriate V-NWDAF which satisfies constraints, such as the current location of the terminal, the requested data type, and the requested analysis type, which are provided when requested by the H-NWDAF. If there are multiple selectable V-NWDAFs, and each V-NWDAF satisfies only some of request conditions, the H-NRF may select multiple V-NWDAFs.

In operation 404, the H-NRF may transmit selected V-NWDAF information to the H-NWDAF by including the same in a response message. The response message may include at least one piece of the following information, for example, information of V-NWDAF identifiers available for information providing for each data type or analysis type requested by the H-NWDAF. For example, if one V-NWDAF provides only some of data types requested by the H-NWDAF, and another V-NWDAF is capable of providing the remaining data types, the response message may include information on an identifier of each V-NWDAF and a data type providable by each V-NWDAF.

In operation 405, the H-NWDAF may transmit a message for requesting providing of terminal and user data or analysis information to each V-NWDAF, by using the V-NWDAF information received from the H-NRF. The message may include at least one piece of the following information, for example, identification information of the roaming terminal, and the terminal and user data or analysis information required by the H-NWDAF and providable by each V-NWDAF, and the like.

In operation 406, the V-NWDAF having received, from the H-NWDAF, the request message for providing information for the roaming terminal may identify information configured by the roaming operator for the V-NWDAF to provide information of the roaming terminal, thereby determining whether to accept the request of the H-NWDAF.

In operation 407, according to the configuration of the roaming operator, transferring of the request to another available V-NWDAF may be performed to accept the request of the H-NWDAF.

Operations 406 and 407 may be performed or may skipped.

In operation 408, the V-NWDAF may respond to the H-NWDAF that information providing has been accepted. The message may include a newly selected V-NWDAF ID when a V-NWDAF is reselected in operation 407. In addition, for the data type or analysis type requested by the H-NWDAF, information on a data type or analysis type, for which information providing is allowed from the roaming operator network to the home operator network, may be included.

FIG. 4 illustrates an operation for an H-NWDAF of a home operator network to request a roaming operator network to provide information. According to this, even when a V-NWDAF of the roaming operator network requests the home operator network to provide information, information on a roaming terminal may be efficiently provided between the operator networks by applying the same operation due to exchanging an H-NWDAF with a V-NWDAF and exchanging an H-NRF with a V-NRF.

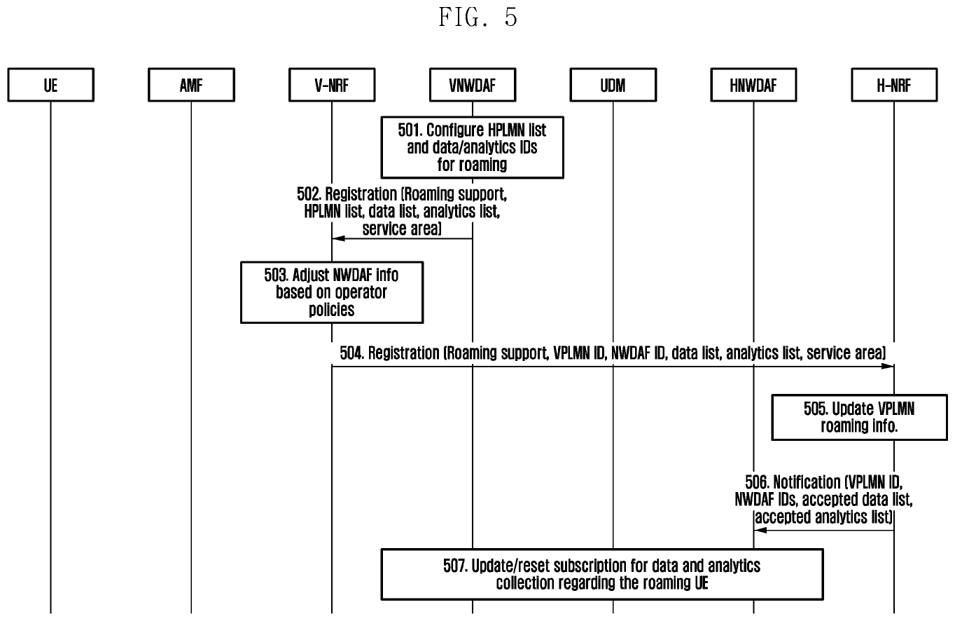

FIG. 5 illustrates a signal procedure of the wireless communication system, for changing or blocking data collection for a roaming terminal according to a change in configuration information of an operator network according to an embodiment of the present disclosure.

When describing a general operation of a provided embodiment with reference to FIG. 5, in operation 501, a roaming operator may modify information configured for a V-NWDAF regarding terminal and user data, an analysis type, etc., which are providable to a home operator network, with respect to a roaming terminal subscribed to a home operator, in consideration of a change in roaming contracts with the home operator, a new legal regulation, etc.

In operation 502, the V-NWDAF may register the modified information in a V-NRF. A message for the registration may include at least one piece of the following information, for example, information on the providable data type, analysis type, allowed service area, etc., which are newly configured for the V-NWDAF by the roaming operator for each home operator. That is, the message may include at least one piece of the following information, for example, information on an indicator indicating whether the V-NWDAF is allowed to provide data of the roaming terminal to a home operator network, an identifier of an allowed home operator network, allowed terminal and user data types, an allowed analysis type, an allowed service area, etc.

In operation 503, the V-NRF may determine, by applying an operator policy, etc., to restrict V-NWDAF information which is to be provided to the home network.

In operation 504, the V-NRF may transmit the updated V-NWDAF information to an H-NRF of each home operator network. The message may include at least one piece of the following information, for example, updated information for an indicator indicating whether the roaming network is allowed to provide data of the roaming terminal to a home operator network, an identifier of the roaming operator network, terminal and user data types allowed to be provided to the home operator, an allowed analysis type, an allowed service area, etc.

In operation 505, the H-NRF may store the updated V-NWDAF information received from the V-NRF.

In operation 506, the H-NRF may transmit a notification message so that the updated policy received from the V-NRF may be applied to each H-NWDAF that is receiving information for the roaming terminal from the roaming operator network. The message may include at least one piece of the following information, for example, information on the roaming operator network identifier received from the V-NRF, a V-NWDAF identifier newly configured by the roaming operator, the data type allowed to be provided from each V-NWDAF to the home operator network, the allowed analysis type, and the like.

In operation 507, when required to receive information on the roaming terminal from the roaming operator network, the H-NWDAF may update or reset or modify or release configured subscription information with the V-NWDAF of the current roaming network by applying the updated V-NWDAF information received from the H-NRF.

FIG. 5 illustrates an operation of transferring change information via an NRF when NWDAF information of an operator network is changed and applying the changed NWDAF information to data collection. According to this, even when an NWDAF function is changed by an operator, efficient data collection may be supported based on the changed NWDAF information.

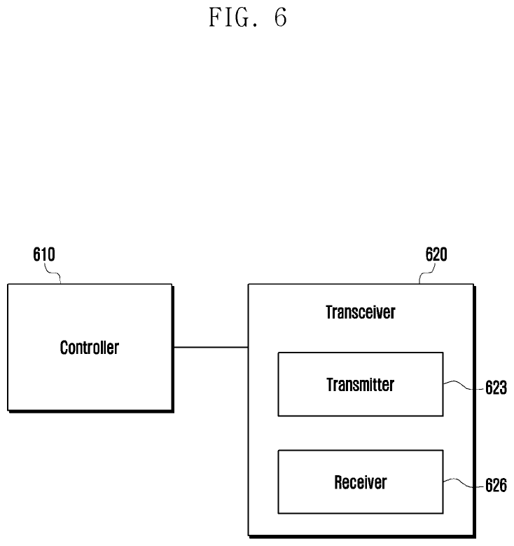

FIG. 6 illustrates a structure of a network entity according to an embodiment of the present disclosure.

The network entity illustrated in FIG. 6 may refer to an entity within a communication system to which the present disclosure may be applied. For example, the network entity may refer to one of the aforementioned V-NRF, V-NWDAF, H-NRF, and H-NWDAF or the entities 100 to 180 within the network illustrated in FIG. 1.

Referring to FIG. 6, the network entity may include a controller 610 and a transceiver 620. In the present disclosure, the controller may be defined to be a circuit, an application-specific integrated circuit, or at least one processor.

The transceiver 620 may include a transmitter 623 and a receiver 626, and may transmit a signal to and receive a signal from another network entity via the transmitter 623 and the receiver 626.

The controller 610 may control overall operations of the network entity according to the embodiment provided in the present disclosure. For example, the controller 610 may control signal flows between respective blocks so as to perform operations according to the aforementioned flowcharts.

In an embodiment, a first NWDAF of a first PLMN may include the transceiver 620 and the controller 610. The controller 610 may be configured to register information on the first NWDAF to a first NRF of the first PLMN, transmit, to the first NRF via the transceiver 620, a first message for requesting NWDAF information to collect, from an operator related to a second PLMN, analytics data for a roaming terminal, receive, from the first NRF via the transceiver 620, a second message for providing information on a second NWDAF of the second PLMN, transmit, to the second NWDAF via the transceiver 620, a third message for requesting the analytics data, based on the information on the second NWDAF, and receive, from the second NWDAF via the transceiver 620, a fourth message notifying that provision of the analytics data is accepted.

In an embodiment, a first NRF of a first PLMN may include the transceiver 620 and the controller 610. The controller 610 may be configured to determine, based on an operator policy, information on a first NWDAF of the first PLMN, obtain, from a second NRF of a second PLMN, information on a second NWDAF of the second PLMN, receive, from the first NWDAF via the transceiver 620, a first message for requesting NWDAF information to collect, from an operator related to the second PLMN, analytics data for a roaming terminal, and transmit, to the first NWDAF via the transceiver 620, a second message for providing the information on the second NWDAF.

The methods according to various embodiments described in the claims or the specification of the present disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the present disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the drawings in which methods of the present disclosure are described, the order of the description does not always correspond to the order in which steps of each method are performed, and the order relationship between the steps may be changed or the steps may be performed in parallel.

Alternatively, in the drawings in which methods of the present disclosure are described, some elements may be omitted and only some elements may be included therein without departing from the essential spirit and scope of the present disclosure.

In the above-described detailed embodiments of the present disclosure, an element included in the present disclosure is expressed in the singular or the plural according to presented detailed embodiments. However, the singular form or plural form is selected appropriately to the presented situation for the convenience of description, and the present disclosure is not limited by elements expressed in the singular or the plural. Therefore, either an element expressed in the plural may also include a single element or an element expressed in the singular may also include multiple elements.

Although specific embodiments have been described in the detailed description of the present disclosure, it will be apparent that various modifications and changes may be made thereto without departing from the scope of the present disclosure. Therefore, the scope of the present disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first network data analytics function (NWDAF) of a first public land mobile network (PLMN) in a communication system, the method comprising:
registering information on the first NWDAF to a first network repository function (NRF) of the first PLMN;
transmitting, to the first NRF, a first message for requesting NWDAF information to collect, from an operator related to a second PLMN, first analytics data for a roaming terminal;
receiving, from the first NRF, a second message for providing information on a second NWDAF of the second PLMN;
transmitting, to the second NWDAF, a third message for requesting the first analytics data based on the information on the second NWDAF; and
receiving, from the second NWDAF, a fourth message notifying that provision of the first analytics data is accepted.

2. The method of claim 1, further comprising:
receiving, from the second NWDAF, a fifth message for requesting second analytics data for a roaming terminal;
determining whether to accept provision of the second analytics data, based on at least one of an operator policy, a security requirement, or a regulation; and
transmitting, to the second NWDAF, a sixth message notifying that the provision of the second analytics data is accepted.

3. The method of claim 1, wherein the first message includes at least one of location information of the roaming terminal, an identifier (ID) of the second PLMN, a list of requested data, or a list of requested analytics.

4. The method of claim 1, wherein the second message includes at least one of an identifier (ID) of the second NWDAF, a list of supported data, or a list of supported analytics.

5. The method of claim 1, wherein registering the information on the first NWDAF further comprises:
identifying configuration information including at least one of an identifier (ID) of the second PLMN, a list of allowed data, or a list of allowed analytics; and
transmitting, to the first NRF, a registration request message including at least one of a roaming support indication, the ID of the second PLMN, the list of allowed data, the list of allowed analytics, or a service area.

6. The method of claim 1, further comprising:
receiving, from the first NRF, a notification message including updated NWDAF information in the second PLMN; and
updating or releasing, based on the updated NWDAF information, the information on the second NWDAF.

7. A method performed by a first network repository function (NRF) of a first public land mobile network (PLMN) in a communication system, the method comprising:
determining, based on an operator policy, information on a first network data analytics function (NWDAF) of the first PLMN;
obtaining, from a second NRF of a second PLMN, information on a second NWDAF of the second PLMN;
receiving, from the first NWDAF, a first message for requesting NWDAF information to collect, from an operator related to the second PLMN, analytics data for a roaming terminal; and
transmitting, to the first NWDAF, a second message for providing the information on the second NWDAF.

8. The method of claim 7, wherein the first message includes at least one of location information of the roaming terminal, an identifier (ID) of the second PLMN, a list of requested data, or a list of requested analytics.

9. The method of claim 7, wherein the second message includes at least one of an identifier (ID) of the second NWDAF, a list of supported data, or a list of supported analytics.

10. The method of claim 7, wherein determining the information on the first NWDAF further comprises:
receiving, from the first NWDAF, a registration request message including at least one of a roaming support indication, an identifier (ID) of the second PLMN, a list of allowed data, a list of allowed analytics, or a service area;
determining, based on the operator policy, the information on the first NWDAF by adjusting at least one of the list of allowed data, the list of allowed analytics, or the service area; and
transmitting, to the second NRF, the information on the first NWDAF.

11. A first network data analytics function (NWDAF) of a first public land mobile network (PLMN) in a communication system, the first NWDAF comprising:
a transceiver; and
a controller operably coupled to the transceiver, the controller configured to:
register information on the first NWDAF to a first network repository function (NRF) of the first PLMN,
transmit, to the first NRF via the transceiver, a first message for requesting NWDAF information to collect, from an operator related to a second PLMN, first analytics data for a roaming terminal,
receive, from the first NRF via the transceiver, a second message for providing information on a second NWDAF of the second PLMN,
transmit, to the second NWDAF via the transceiver, a third message for requesting the first analytics data based on the information on the second NWDAF, and
receive, from the second NWDAF via the transceiver, a fourth message notifying that provision of the first analytics data is accepted.

12. The first NWDAF of claim 11, wherein the controller is further configured to:
receive, from the second NWDAF via the transceiver, a fifth message for requesting second analytics data for a roaming terminal;
determine whether to accept provision of the second analytics data, based on at least one of an operator policy, a security requirement, or a regulation; and
transmit, to the second NWDAF via the transceiver, a sixth message notifying that the provision of the second analytics data is accepted.

13. The first NWDAF of claim 11, wherein the first message includes at least one of location information of the roaming terminal, an identifier (ID) of the second PLMN, a list of requested data, or a list of requested analytics.

14. The first NWDAF of claim 11, wherein the second message includes at least one of an identifier (ID) of the second NWDAF, a list of supported data, or a list of supported analytics.

15. The first NWDAF of claim 11, wherein the controller is further configured to:
identify configuration information including at least one of an identifier (ID) of the second PLMN, a list of allowed data, or a list of allowed analytics; and
transmit, to the first NRF via the transceiver, a registration request message including at least one of a roaming support indication, the ID of the second PLMN, the list of allowed data, the list of allowed analytics, or a service area.

16. The first NWDAF of claim 11, wherein the controller is further configured to:
receive, from the first NRF via the transceiver, a notification message including updated NWDAF information in the second PLMN; and
update or release, based on the updated NWDAF information, the information on the second NWDAF.

17. A first network repository function (NRF) of a first public land mobile network (PLMN) in a communication system, the first NRF comprising:
a transceiver; and
a controller operably coupled to the transceiver, the controller configured to:
determine, based on an operator policy, information on a first network data analytics function (NWDAF) of the first PLMN,
obtain, from a second NRF of a second PLMN, information on a second NWDAF of the second PLMN,
receive, from the first NWDAF via the transceiver, a first message for requesting NWDAF information to collect, from an operator related to the second PLMN, analytics data for a roaming terminal, and
transmit, to the first NWDAF via the transceiver, a second message for providing the information on the second NWDAF.

18. The first NRF of claim 17, wherein the first message includes at least one of location information of the roaming terminal, an identifier (ID) of the second PLMN, a list of requested data, or a list of requested analytics.

19. The first NRF of claim 17, wherein the second message includes at least one of an identifier (ID) of the second NWDAF, a list of supported data, or a list of supported analytics.

20. The first NRF of claim 17, wherein the controller is further configured to:
receive, from the first NWDAF via the transceiver, a registration request message including at least one of a roaming support indication, an identifier (ID) of the second PLMN, a list of allowed data, a list of allowed analytics, or a service area;
determine, based on the operator policy, the information on the first NWDAF by adjusting at least one of the list of allowed data, the list of allowed analytics, or the service area; and
transmit, to the second NRF via the transceiver, the information on the first NWDAF.
